(19) United States
(12) Patent Application Publication
(10) Pub. No.: US 2025/0364847 A1
(43) Pub. Date: Nov. 27, 2025

(54) ELECTRONIC DEVICE INCLUDING WIRELESS CHARGING DEVICE

(71) Applicant: Samsung Electronics Co., Ltd., Suwon-si (KR)

(72) Inventors: Jaehyoung PARK, Suwon-si (KR); Yeonsik YU, Suwon-si (KR)

(21) Appl. No.: 19/289,611

(22) Filed: Aug. 4, 2025

Related U.S. Application Data
(63) Continuation of application No. PCT/KR2024/002247, filed on Feb. 21, 2024.

(30) Foreign Application Priority Data
Feb. 28, 2023 (KR) 10-2023-0026920

(51) Int. Cl. H02J 50/90; H01F 27/06; H02J 50/00; H02J 50/12

(52) U.S. Cl. CPC H02J 50/90; H01F 27/06; H02J 50/005; H02J 50/12; H01F 2027/065

(57) ABSTRACT

An electronic device including a wireless charging device is provided. The wireless charging device includes a power transmission coil for wirelessly transmitting power to the electronic device, and a first coil which is disposed inside the power transmission coil and by which a magnetic field is formed in a first direction. The electronic device includes a power reception coil for wirelessly receiving power from the power transmission coil, and a second coil which is disposed inside the power reception coil and by which a magnetic field is formed in a second direction opposite the first direction, wherein the first coil and the second coil are configured to be matched so that the power transmission coil and the power reception coil are aligned.

### CROSS-REFERENCE TO RELATED APPLICATION(S)

This application is a continuation application, claiming priority under 35 U.S.C. § 365(c), of an International application No. PCT/KR2024/002247, filed on Feb. 21, 2024, which is based on and claims the benefit of a Korean patent application number 10-2023-0026920, filed on Feb. 28, 2023, in the Korean Intellectual Property Office, the disclosure of which is incorporated by reference herein in its entirety.

### BACKGROUND

### 1. Field

The disclosure relates to an electronic device including a wireless charging device.

### 2. Description of Related Art

The use of various electronic devices, such as mobile terminals and wearable devices is increasing.

The electronic devices may include batteries to supply power necessary for performing various functions. The electronic devices may charge batteries through wired charging or wireless charging.

For example, in the wireless charging, when an electronic device is placed on a charging device, power is supplied to a power reception coil disposed inside the electronic device through a power transmission coil disposed inside the charging device, thereby charging the battery of the electronic device.

The above information is presented as background information only to assist with an understanding of the disclosure. No determination has been made, and no assertion is made, as to whether any of the above might be applicable as prior art with regard to the disclosure.

### SUMMARY

The method for wirelessly charging an electronic device by using a charging device may include an electromagnetic induction method using a coil, a resonance method using resonance, or a radio wave radiation method that converts electrical energy into microwaves for transmission.

For example, the electromagnetic induction method uses the magnetic field generated by coils to wirelessly transmit power from a wireless charging device (e.g., a wireless charging transmitter) to an electronic device (e.g., a wireless charging receiver), thereby charging a battery.

The electromagnetic induction method can improve charging efficiency when the centers of a coil in the wireless charging device (e.g., a power transmission coil) and a coil in the electronic device (e.g., a power reception coil) are aligned.

A magnet may be used to align the coil of the wireless charging device and the coil of the electronic device. When a magnet is used to align the coil of the wireless charging device and the coil of the electronic device, the weight and volume of the wireless charging device may increase. When fast-charging the electronic device by using the wireless charging device, if the magnetization of the magnet weakens, the performance of aligning the coil of the wireless charging device and the coil of the electronic device may deteriorate.

Aspects of the disclosure are to address at least the above-mentioned problems and/or disadvantages and to provide at least the advantages described below. Accordingly, an aspect of the disclosure is to provide an electronic device including a wireless charging device that can align a power transmission coil of the wireless charging device and a power reception coil of the electronic device by using, as electromagnets, a first coil disposed in the power transmission coil of the wireless charging device and a second coil disposed in the power reception coil of the electronic device.

Additional aspects will be set forth in part in the description which follows and, in part, will be apparent from the description, or may be learned by practice of the presented embodiments.

In accordance with an aspect of the disclosure, an electronic device including a wireless charging device is provided. The wireless charging device includes a power transmission coil configured to wirelessly transmit power to an electronic device and a first coil disposed inside the power transmission coil and configured to form a magnetic field in a first direction, wherein the electronic device includes a power reception coil configured to wirelessly receive power from the power transmission coil and a second coil disposed inside the power reception coil and configured to form a magnetic field in a second direction opposite to the first direction, wherein the first coil and the second coil are configured to be matched so that the power transmission coil and the power reception coil are aligned

According to various embodiments of the disclosure, by using the first coil disposed in the power transmission coil of the wireless charging device and the second coil disposed in the power reception coil of the electronic device as electromagnets, it is possible to improve the attachment force for aligning the power transmission coil of the wireless charging device and the power reception coil of the electronic device.

According to various embodiments of the disclosure, by using the first coil disposed in the power transmission coil of the wireless charging device and the second coil disposed in the power reception coil of the electronic device as electromagnets, it is possible, for example, to omit the placement of a magnet in the wireless charging device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a power management module and a battery according to an embodiment of the disclosure;

FIG. 3A schematically illustrates an operation in which a wireless charging device (e.g., a wireless charging transmitter) charges an electronic device (e.g., a wireless charging receiver) according to an embodiment of the disclosure;

FIG. 3B schematically illustrates a wireless charging environment for a wireless charging device and an electronic device according to an embodiment of the disclosure;

FIG. 3C illustrates an operation in which a wireless charging device detects an object, such as an electronic device according to an embodiment of the disclosure;

FIG. 4 schematically illustrates configurations of a wireless charging device and an electronic device according to an embodiment of the disclosure;

FIG. 5 schematically illustrates the configuration of a first coil or a second coil according to an embodiment of the disclosure; and

FIG. 6 schematically illustrates the configuration of a first coil or a second coil according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

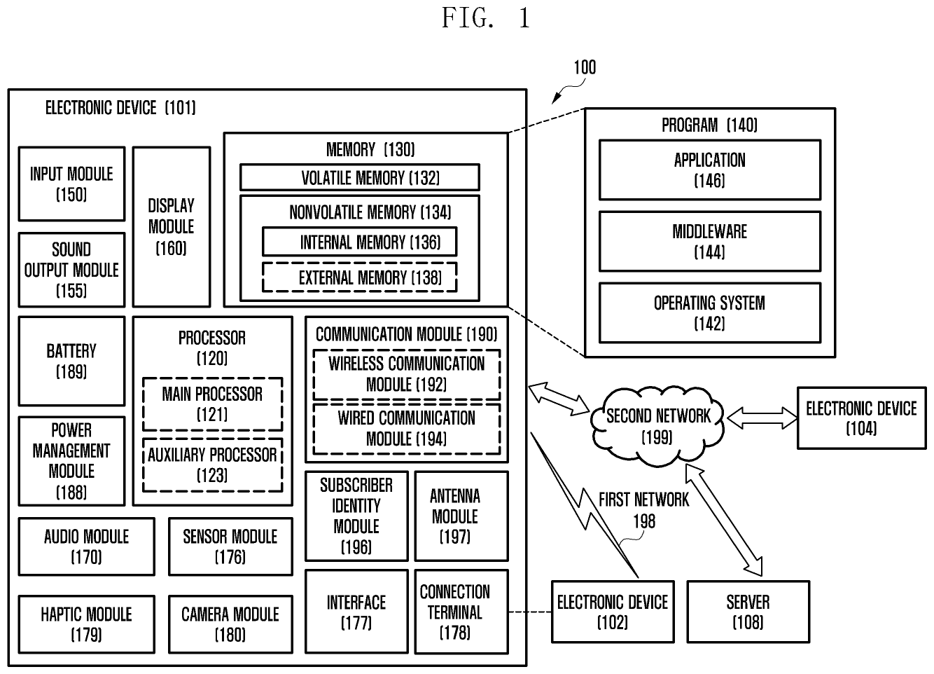

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

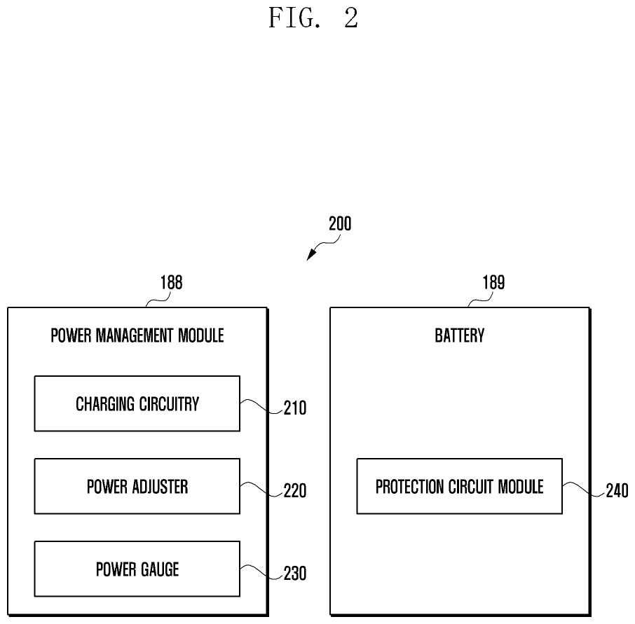

FIG. 2 is a block diagram 200 illustrating a power management module and a battery according to an embodiment of the disclosure.

Referring to FIG. 2, the power management module 188 may include charging circuitry 210, a power adjuster 220, or a power gauge 230. The charging circuitry 210 may charge the battery 189 by using power supplied from an external power source outside the electronic device 101. According to an embodiment of the disclosure, the charging circuitry 210 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 189, and may charge the battery 189 using the selected charging scheme. The external power source may be connected with the electronic device 101, for example, directly via the connecting terminal 178 or wirelessly via the antenna module 197.

The power adjuster 220 may generate a plurality of powers having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment of the disclosure, the power adjuster 220 may be implemented in the form of a low drop out (LDO) regulator or a switching regulator. The power gauge 230 may measure use state information about the battery 189 (e.g., a capacity, a number of times of charging or discharging, a voltage, or a temperature of the battery 189).

The power management module 188 may determine, using, for example, the charging circuitry 210, the power adjuster 220, or the power gauge 230, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment of the disclosure, at least some of the functions of the power management module 188 may be performed by an external control device (e.g., the processor 120).

The battery 189, according to an embodiment of the disclosure, may include a battery protection circuit 240. The battery protection circuit 240 may perform one or more of various functions (e.g., a pre-cutoff function) to prevent a performance deterioration of, or a damage to, the battery 189. The battery protection circuit 240, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment of the disclosure, at least part of the charging state information or use state information regarding the battery 189 may be measured using a corresponding sensor (e.g., a temperature sensor) of the sensor module 176, the power gauge 230, or the power management module 188. According to an embodiment of the disclosure, the corresponding sensor (e.g., a temperature sensor) of the sensor module 176 may be included as part of the battery protection circuit 240, or may be disposed near the battery 189 as a separate device.

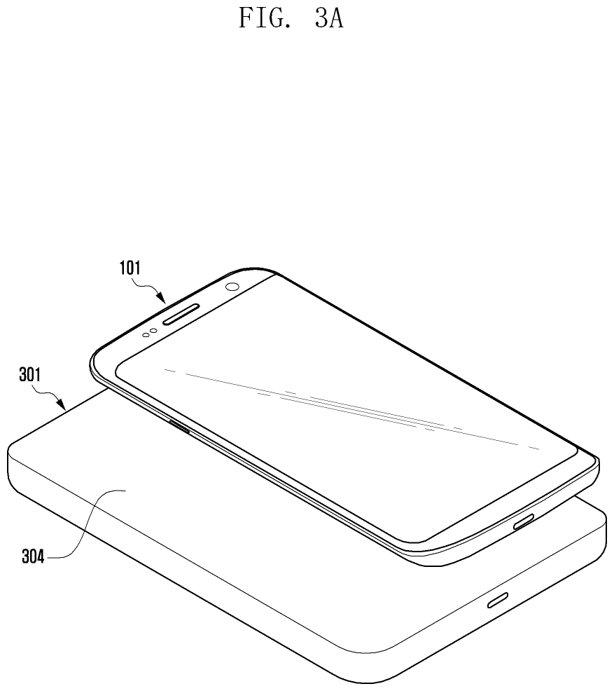

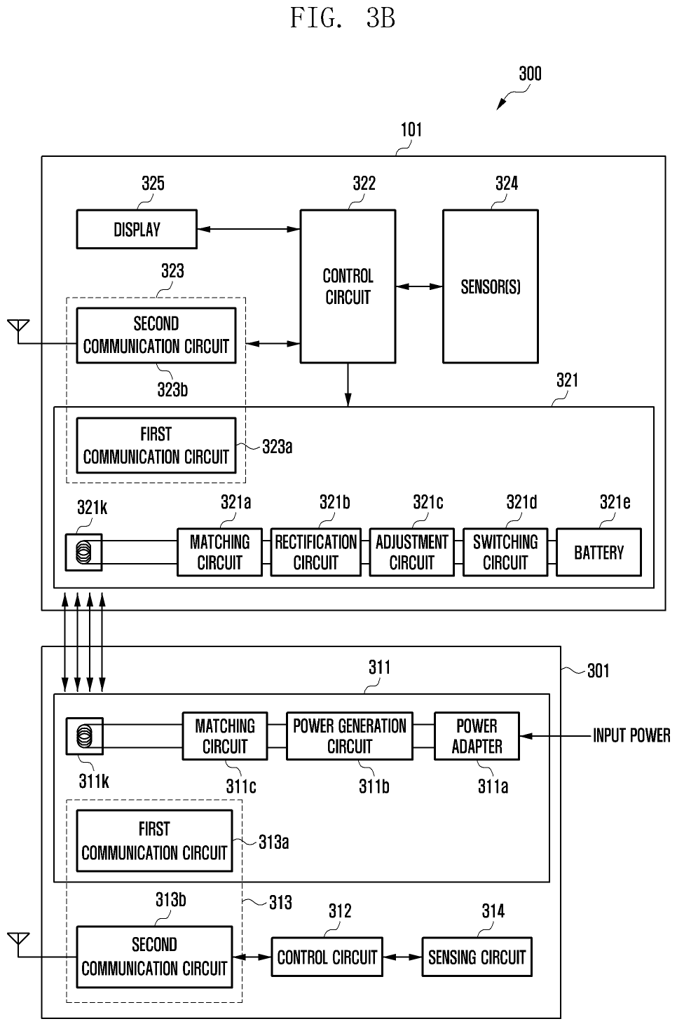

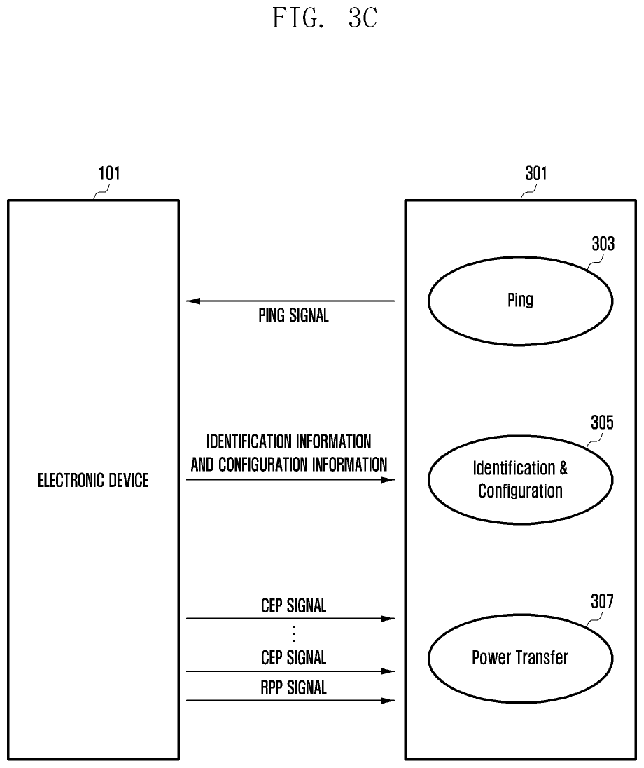

FIG. 3A schematically illustrates an operation in which a wireless charging device charges an electronic device according to an embodiment of the disclosure.

Referring to FIG. 3A, a wireless charging device 301 (e.g., a wireless charging transmitter) according to various embodiments of the disclosure may transmit wireless power to charge an electronic device 101 (e.g., a wireless charging receiver).

According to an embodiment of the disclosure, when a battery (e.g., battery 189 in FIG. 1) of the electronic device 101 is in a discharged state, or when the amount of available power is below a designated level, the wireless charging device 301 may transmit wireless power to charge the battery 189 of the electronic device 101.

According to an embodiment of the disclosure, the electronic device 101 may include at least one of a smartphone, a wearable device (e.g., a watch and/or augmented reality (AR) glasses), or wireless earphones. The wireless charging device 301 may be a device that is identical or similar to the electronic device 101. For example, the wireless charging device 301 may include a wireless charging pad or a smartphone. The wireless charging device 301 may be implemented by at least one of the electronic device 101, the external electronic devices 102 and/or 104 disclosed in FIG. 1. The wireless charging device 301 may include at least one of the components of the electronic device 101.

According to an embodiment of the disclosure, the wireless charging device 301 may detect that the electronic device 101 is placed on (e.g., adjacent to or in contact with) the top of a housing 304 while in a standby state for charging the electronic device 101. For example, the top of the housing 304 of the wireless charging device 301 may refer to a surface adjacent to a coil for wireless charging (e.g., a power transmission coil 311k in FIG. 3B) or a surface located in the direction in which the magnetic force of the coil for wireless charging is transmitted.

According to an embodiment of the disclosure, the wireless charging device 301 may periodically or at designated times transmit a first ping signal (e.g., one of an analog ping signal, a Q ping signal, or a digital ping signal) through the wireless charging coil, and the first ping signal may be used to identify whether the electronic device 101 is adjacent to or in contact with the wireless charging device 301. The electronic device 101 may transmit a feedback signal (e.g., a response signal, identification information, configuration information, and/or a signal strength packet (SSP) signal) to the wireless charging device 301 in response to the first ping signal transmitted from the wireless charging device 301. The Q ping signal may be a type of analog ping signal, and may be used to detect a change (e.g., at least one of current, voltage, or frequency) in a signal applied to a coil of the wireless charging device 301 to identify the degree of resonance point matching of the coil.

According to an embodiment of the disclosure, the wireless charging device 301 may identify the presence or absence of an object (e.g., metal) disposed on the top of the housing 304 of the wireless charging device 301, based on the first ping signal to determine whether the electronic device 101 is placed on the top of the housing 304. For example, the wireless charging device 301 may identify a change in electrical energy (e.g., current or voltage) measured during transmission of the first ping signal and, based on the identified change in electrical energy, identify whether the electronic device 101 has been placed (e.g., present). When the presence of the electronic device 101 is identified, the wireless charging device 301 may adjust at least some of the multiple parameters related to the first ping signal.

According to an embodiment of the disclosure, a guide (e.g., an indicator) for a location where the electronic device 101 should be placed (e.g., a location of the coil or a chargeable location) may be displayed on the top of the housing 304 of the wireless charging device 301.

FIG. 3B schematically illustrates a wireless charging environment 300 for a wireless charging device and an electronic device according to an embodiment of the disclosure.

Referring to FIG. 3B, according to an embodiment of the disclosure, a wireless charging device 301 according to various embodiments of the disclosure may wirelessly transmit power to charge a battery 321e (e.g., battery 189 in FIG. 1) of an electronic device 101 when the electronic device 101 is placed on the top of the housing 304.

According to an embodiment of the disclosure, the wireless charging device 301 may include a power transmitter 311, a control circuit 312, a communication circuit 313, and/or a sensing circuit 314.

According to an embodiment of the disclosure, the power transmitter 311 may receive power from an external power source (e.g., a commercial power source, an auxiliary battery device, a laptop computer, a desktop computer, or a smartphone).

According to various embodiments of the disclosure, the power transmitter 311 may include a power adapter 311a, a power generation circuit 311b, a matching circuit 311c, and a power transmission coil 311k.

According to an embodiment of the disclosure, the power adapter 311a may convert a voltage of power that is input from an external power source (e.g., a travel adapter (TA)). The power generation circuit 311b may generate power required for power transmission from the converted voltage. The matching circuit 311c may maximize the efficiency between the power transmission coil 311k and a power reception coil 321k of the electronic device 101.

According to various embodiments of the disclosure, when wireless power is transmitted to the multiple electronic devices 101, the power transmitter 311 may include, in plurality, at least one of the power adapter 311a, the power generation circuit 311b, the matching circuit 311c, or the power transmission coil 311k.

According to an embodiment of the disclosure, the power transmission coil 311k may include multiple coils grouped in the same layer and/or in different layers. The wireless charging device 301 may select some of the multiple coils disposed in the same layer and/or in different layers to charge the electronic device 101. The power transmission coil 311k may be disposed on a printed circuit board. The power transmission coil 311k may be formed by being wound at least once on the printed circuit board.

According to an embodiment of the disclosure, the control circuit 312 may perform overall control for transmitting power through the wireless charging device 301. The control circuit 312 may be operatively connected to the power transmitter 311, the communication circuit 313, and the sensing circuit 314. The control circuit 312 may generate various messages required for wireless power transmission and transmit the messages to the communication circuit 313. Based on information received from the electronic device 101 (e.g., the wireless charging receiver) via the communication circuit 313, the control circuit 312 may calculate power (or the amount of power) to be transmitted to the electronic device 101. The control circuit 312 may control the power transmitter 311 such that the calculated power is transmitted to the electronic device 101 via the power transmission coil 311k.

According to an embodiment of the disclosure, the communication circuit 313 (e.g., the communication module 190 in FIG. 1) may include at least one of a first communication circuit 313a or a second communication circuit 313b. The first communication circuit 313a may communicate with a first communication circuit 323a of the electronic device 101 by using a frequency in a band that is the same as the frequency used for wireless power transmission in the power transmission coil 311k, or adjacent to the frequency used for wireless power transmission (e.g., in-band communication in which a power signal or a communication signal is transmitted using the power transmission coil 311k). The second communication circuit 313b may communicate with a second communication circuit 323b of the electronic device 101 by using a frequency different from a frequency used for wireless power transmission in the power transmission coil 311k (e.g., out-band communication in which a communication signal is transmitted using the antenna module 197 in FIG. 1). The second communication circuit 313b may receive information (e.g., information about rectified voltage (Vrec), information about current flowing in the rectified circuit (Iout), various packets, or messages) regarding the charging state of the electronic device 101 from the second communication circuit 323b of the electronic device 101 by using, for example, at least one of Bluetooth, Bluetooth low energy (BLE), Wi-Fi, or near-field communication (NFC). The second communication circuit 313b may also communicate with another electronic device (e.g., the external electronic devices 102 or 104 in FIG. 1) that does not perform wireless charging. The other electronic device may include a display (e.g., the display module 160 in FIG. 1).

According to an embodiment of the disclosure, the sensing circuit 314 (e.g., the sensor module 176 in FIG. 1) may include at least one sensor. The wireless charging device 301 may use the at least one sensor to detect at least one state regarding the wireless charging device 301. For example, the sensing circuit 314 may include at least one of a temperature sensor, a motion sensor, a proximity sensor, or a current (or voltage) sensor.

According to various embodiments of the disclosure, the temperature sensor may detect a temperature state of the wireless charging device 301. The motion sensor may detect a motion state of the wireless charging device 301. The proximity sensor may detect a specific object (e.g., the electronic device 101 or a metal object other than the electronic device 101) that are in proximity and/or contact with the top of the housing 304 of the wireless charging device 301. The current (or voltage) sensor may detect an output signal state (e.g., at least one of a current magnitude, a voltage magnitude, or a power magnitude) of the wireless charging device 301. The current (or voltage) sensor may measure a signal for the power transmitter 311. For example, the current (or voltage) sensor may measure signals for at least some regions of the matching circuit 311c and the power generation circuit 311b. The current (or voltage) sensor may include a circuit for measuring a signal for a front end of the power transmission coil 311k.

According to an embodiment of the disclosure, the sensing circuit 314 may detect the electronic device 101 (e.g., a wireless charging receiver), placed on the top of the housing 304 of the wireless charging device 301 (e.g., a wireless charging transmitter), or an external object (e.g., metal) other than the electronic device 101.

According to various embodiments of the disclosure, when the wireless charging device 301 is a mobile terminal (e.g., the electronic device 101), the wireless charging device 301 may include a display (e.g., the display module 160 in FIG. 1). The wireless charging device 301 may use the display to display various pieces of information related to wireless charging (e.g., information about the charging state of the wireless charging device 301, information about the charging state of the electronic device 101, information about detection of the electronic device 101, or information about detection of an external object (e.g., metal)).

Referring to FIG. 3B, the electronic device 101 (e.g., a wireless charging receiver) according to various embodiments of the disclosure may wirelessly receive power from the wireless charging device 301 when placed on the top of the housing 304 of the wireless charging device 301.

According to an embodiment of the disclosure, the electronic device 101 may include a power receiver 321, a control circuit 322, a communication circuit 323, at least one sensor 324 and/or a display 325. In the description of the electronic device 101, the description of the components corresponding to those of the wireless charging device 301 may be omitted.

According to an embodiment of the disclosure, the power receiver 321 may include a power reception coil 321k for receiving wireless power from the wireless charging device 301 (e.g., the power transmission coil 311k), a matching circuit 321a, a rectification circuit 321b for rectifying received AC power to DC, an adjustment circuit 321c for adjusting a charging voltage, a switching circuit 321d, and/or a battery 321e (e.g., the battery 189 in FIG. 1).

According to an embodiment of the disclosure, the control circuit 322 may perform overall control related to wireless power reception (or wireless charging) of the electronic device 101. For example, the control circuit 322 may include the processor 120 disclosed in FIG. 1. The control circuit 322 may generate various messages related to wireless charging to transmit the message to the communication circuit 323.

According to an embodiment of the disclosure, the communication circuit 323 (e.g., the communication module 190 in FIG. 1) may include at least one of a first communication circuit 323a or a second communication circuit 323b. The first communication circuit 323a may communicate with the first communication circuit 313a of the wireless charging device 301 by using the power reception coil 321k. The second communication circuit 323b may communicate with the second communication circuit 313b of the wireless charging device 301 by using at least one of Bluetooth, Bluetooth low energy, Wi-Fi, and near-field communication.

According to an embodiment of the disclosure, the sensor 324 (e.g., the sensor module 176 in FIG. 1) may include at least one of a current (or voltage) sensor, a temperature sensor, a proximity sensor, a light sensor, or an acceleration sensor.

According to an embodiment of the disclosure, the display 325 (e.g., the display module 160 in FIG. 1) may display various pieces of information related to wireless power reception (or wireless charging).

According to an embodiment of the disclosure, when the wireless charging device 301 is an electronic device (e.g., a smartphone) that is the same as or similar to the electronic device 101, the wireless charging device 301 may include the same components as the electronic device 101.

FIG. 3C illustrates an operation in which a wireless charging device detects an object such as an electronic device according to an embodiment of the disclosure.

Referring to FIG. 3C, a wireless charging device 301 (e.g., a wireless charging transmitter) according to various embodiments of the disclosure may perform a function (e.g., a Tx function) of wirelessly transmitting power to an electronic device 101 (e.g., a wireless charging receiver).

According to an embodiment of the disclosure, when the electronic device 101 is placed, for example, on the top of the housing 304, the wireless charging device 301 may detect and authenticate the electronic device 101 and transmit wireless power to the electronic device 101.

According to an embodiment of the disclosure, the wireless charging device 301 may perform at least one of a ping operation 303, an identification & configuration operation 305, and a power transfer operation 307. The wireless charging device 301 may transmit or receive at least one signal or data to or from the electronic device 101 by using the ping operation 303, the identification & configuration operation 305, and the power transfer operation 307.

According to an embodiment of the disclosure, a control circuit (e.g., the control circuit 312 in FIG. 3B) of the wireless charging device 301 may transmit a signal (e.g., a ping signal) at predetermined time intervals by using a ping operation 303 to detect the electronic device 101 present within a predetermined range. For example, the control circuit 312 of the wireless charging device 301 may transmit a first ping signal or a second ping signal to the electronic device 101. The transmission period of the first ping signal may be shorter than the transmission period of the second ping signal. The first ping signal may have a transmission period of about 0.1 to 10 ms. The second ping signal may have a transmission period of about 65 to 70 ms. The first ping signal may include an analog ping signal or a Q ping signal. The second ping signal may include a digital ping signal. The transmission period of the first ping signal and the transmission period of the second ping signal are exemplary and may be changed based on the settings of a user of the wireless charging device 301 and/or the electronic device 101.

According to an embodiment of the disclosure, the wireless charging device 301 may receive a feedback signal (e.g., a response signal, identification information, configuration information, and/or an SSP signal) from the electronic device 101 in response to the first ping signal or the second ping signal, and detect the presence or absence of the electronic device 101.

According to an embodiment of the disclosure, the wireless charging device 301 may use the analog ping signal, which is the first ping signal, to detect, for example, a change in current in the power generation circuit 311b, depending on the type and location of a specific object (e.g., the electronic device 101 or a metal object other than the electronic device), thereby identifying whether the specific object is placed on the top of the housing 304.

According to an embodiment of the disclosure, the wireless charging device 301 may use the Q ping signal, which is the first ping signal, to detect a change in the damping factor (e.g., Q value) and natural frequency of the power transmission coil 311k, depending on the type and location of a specific object (e.g., the electronic device 101 or a metal object other than the electronic device), thereby identifying whether the specific object is placed on the top of the housing 304.

According to an embodiment of the disclosure, when it is identified, via the first ping signal, that a specific object (e.g., the electronic device 101) is placed on the top of the housing 304, the wireless charging device 301 may use the digital ping signal, which is the second ping signal, to determine the type and location of the specific object placed on the top of the housing 304. For example, when the wireless charging device 301 transmits the digital ping signal, which is the second ping signal, to the electronic device 101, a voltage equal to or higher than a specific value may be induced in the rectification circuit 321b of the electronic device 101, and a signal strength packet (SSP) signal including information about the strength of the induced voltage (e.g., voltage value information) may be transmitted to the wireless charging device 301. The wireless charging device 301 may use the transmitted SSP signal to identify the type and location of the electronic device 101 placed on the top of the housing 304.

According to an embodiment of the disclosure, the control circuit 312 of the wireless charging device 301 may, in the ping operation 303, configure multiple parameters related to the transmission of the first ping signal or the second ping signal. For example, the control circuit 312 of the wireless charging device 301 may configure multiple parameters related to at least one of a frequency of the first ping signal or the second ping signal, a voltage applied to a power transmission circuit (e.g., the power transmitter 311 or the power transmission coil 311k in FIG. 3B) to transmit the first ping signal or the second ping signal, or a transmission period of the first ping signal or the second ping signal. The multiple parameters may be provided as default values in the initial configuration of the wireless charging device 301.

According to an embodiment of the disclosure, the control circuit 312 of the wireless charging device 301 may determine, in the ping operation 303, whether a specific object (e.g., the electronic device 101) is present on the top of the housing 304 of the wireless charging device 301. The control circuit 312 of the wireless charging device 301 may transmit a ping signal based on the multiple parameters related to the transmission of the first ping signal or the second ping signal during an operation interval (or a wireless charging standby state) related to the ping operation 303, and may identify electrical energy (e.g., at least one of current and voltage) measured at the power transmitter 311 (or the power transmission coil 311k) in response to the ping signal transmission.

According to an embodiment of the disclosure, the control circuit 312 of the wireless charging device 301 may identify at least one of a relationship between a voltage measured at the power transmitter 311 (or the power transmission coil 311k) and a designated threshold voltage and a relationship between a current measured at the power transmitter 311 (or the power transmission coil 311k) and a designated threshold current in response to the transmission of the first ping signal or the second ping signal, and determine, based on the identification result, whether an object is present on the top of the wireless charging device 301.

According to an embodiment of the disclosure, the control circuit 312 of the wireless charging device 301 may detect the state of an object present on the top of the wireless charging device 301 (e.g., the type of object, the size of the object, or the placement state of the object) or a change in the state of the object, based on a change in electrical energy (e.g., at least one of current and voltage) measured at the power transmitter 311 (or the power transmission coil 311k), in response to the transmission of the first ping signal or the second ping signal.

According to an embodiment of the disclosure, it is identified that a specific object (e.g., the electronic device 101 or a metal object other than the electronic device) is placed on the top of the housing 304 of the wireless charging device 301, the control circuit 312 of the wireless charging device 301 may change or adjust at least some of the multiple parameters related to the transmission of the first ping signal or the second ping signal to suppress noise caused by the object (e.g., vibration of the object and/or noise in the audible frequency band caused by the vibration), the degree of heat generation of the object, or degradation of the wireless charging device 301 caused by the object (e.g., heat generation of the wireless charging device 301 caused by induction heating from the object). The control circuit 312 of the wireless charging device 301 may output a designated notification (e.g., light emission, vibration, or sound) to provide notification of the presence of the specific object.

According to an embodiment of the disclosure, when the electronic device 101 is detected, the control circuit 312 of the wireless charging device 301 (e.g., the wireless charging receiver) may receive identification information and configuration information of the electronic device 101 in the identification & configuration operation 305

According to various embodiments of the disclosure, the identification information may include at least one piece of information for authenticating the electronic device 101 (e.g., a wireless communication ID of the electronic device 101). The control circuit 312 of the wireless charging device 301 may determine that the detected electronic device 101 is a valid device when the identification information matches information pre-stored in memory (e.g., the memory 130 in FIG. 1) (e.g., the wireless communication ID of the electronic device 101 that is authorized to share wireless power with the wireless charging device 301). The configuration information may include various pieces of information required for the electronic device 101 to receive wireless power from the wireless charging device 301.

According to an embodiment of the disclosure, when the electronic device 101 is authenticated or selected based on the identification information and the configuration information, the control circuit 312 of the wireless charging device 301 may transmit wireless power to the electronic device 101 in the power transfer operation 307. In the power transfer operation 307, the control circuit 312 of the wireless charging device 301 may receive, from the electronic device 101, at least one of at least one control error packet (CEP) signal, including notification information of power (or the amount of power) required by the electronic device 101 for charging, and a received power packet (RPP) signal, including magnitude information of power (or the amount of power) received by the electronic device 101. The control circuit 312 of the wireless charging device 301 may adjust the wireless power transmitted to the electronic device 101, based on at least one of the at least one CEP signal and the RPP signal.

According to an embodiment of the disclosure, the electronic device 101 may transmit the at least one CEP signal and the RPP signal at designated intervals or upon the occurrence of a specific event (e.g., a change in the state of the electronic device 101). The at least one CEP signal and the RRP signal may be transmitted at different intervals.

According to various embodiments of the disclosure, when the wireless charging device 301 includes multiple coils, the wireless charging device 301 may perform the ping operation 303, the identification & configuration operation 305, and the power transfer operation 307 through each of the multiple coils. According to an embodiment of the disclosure, the wireless charging device 301 may perform the ping operation 303 through the multiple coils simultaneously, or may perform the ping operation 303 through the multiple coils, based on a designated pattern or sequence. According to an embodiment of the disclosure, when an electronic device (e.g., the electronic device 101) is detected through the multiple coils, the wireless charging device 301 may perform the identification & configuration operation 305 through each of the coils through which the electronic device (e.g., the electronic device 101) is detected, or may perform the identification & configuration operation 305 through a coil which is detected above a designated threshold. According to an embodiment of the disclosure, the wireless charging device 301 may, in a power transfer operation 307, transmit power to the electronic device (e.g., electronic device 101) via each of the multiple coils, and receive feedback from the electronic device (e.g., the electronic device 101).

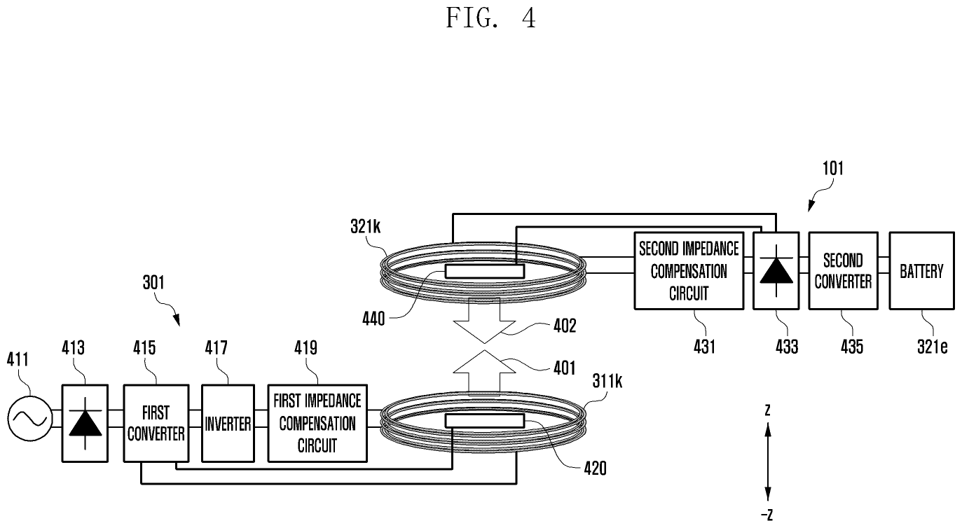

FIG. 4 schematically illustrates configurations of a wireless charging device and an electronic device according to an embodiment of the disclosure.

Referring to FIG. 4, components that are substantially identical to those in the embodiments disclosed in FIGS. 1, 2, 3A, 3B, and 3C are assign identical reference numerals, and redundant descriptions of functions thereof may be omitted.

According to various embodiments of the disclosure, a wireless charging device 301 may include a power supply 411, a first rectification circuit 413, a first converter 415, an inverter 417, a first impedance compensation circuit 419, a power transmission coil 311k, and/or a first coil 420.

According to an embodiment of the disclosure, the wireless charging device 301 may charge a battery 321e of an electronic device 101 via the power transmission coil 311k.

According to an embodiment of the disclosure, the power supply 411 (e.g., the power adapter 311a in FIG. 3B) may supply power required for the wireless charging device 301. The power supply 411 may supply power to the wireless charging device 301 via a travel adaptor (TA) or a USB. The power supply 411 may include an external connection terminal capable of performing USB charging or on-the-go (OTG) power supply.

According to an embodiment of the disclosure, the first rectification circuit 413 may convert alternating current, received via the power supply 411, to direct current. For example, the first rectification circuit 413 may rectify power of an alternating current waveform received via the power supply 411 to power of a direct current waveform. For example, the first rectification circuit 413 may include a bridge diode.

According to an embodiment of the disclosure, the first converter 415 may convert the power rectified by the first rectification circuit 413 to a configured gain. The first converter 415 may convert the rectified power such that a voltage at an output end is a specific voltage. The first converter 415 may transmit the converted power to the power transmission coil 311k and the first coil 420. The first coil 420 may receive the power converted by the first converter 415 and may operate as an electromagnet. For example, the first coil 420 may form a magnetic field in a first direction 401 (e.g., the z-axis direction).

According to various embodiments of the disclosure, the first converter 415 may include a DC-DC converter capable of converting to a voltage used by the wireless charging device 301. For example, the first converter 415 may step down or step up the voltage used by the wireless charging device 301.

According to an embodiment of the disclosure, the inverter 417 may convert direct current received through the first converter 415 to alternating current. For example, the inverter 417 may invert power of a direct current waveform received via the first converter 415 to an alternating current waveform.

According to an embodiment of the disclosure, the first impedance compensation circuit 419 may compensate for the impedance of alternating current power transmitted through the inverter 417. The first impedance compensation circuit 419 may transmit the impedance-compensated alternating current power to the power transmission coil 311k.

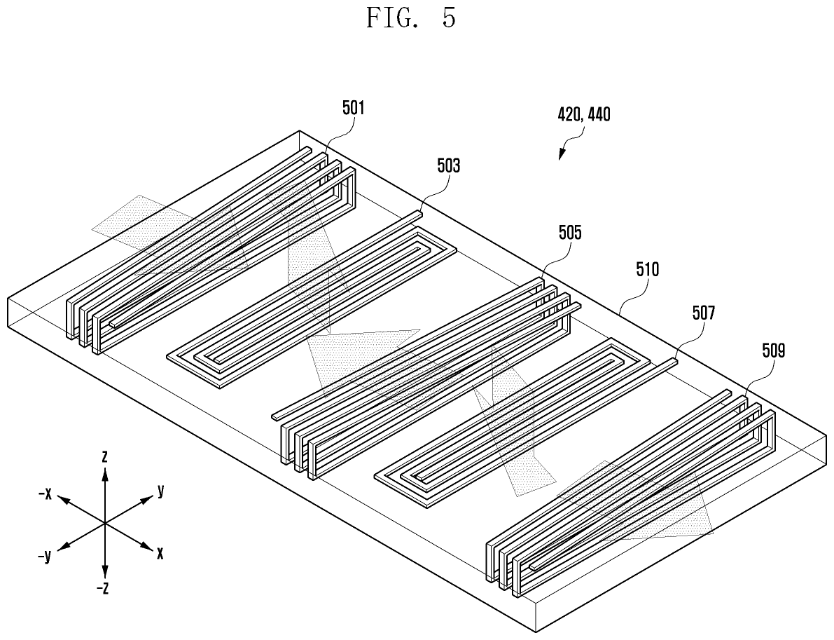

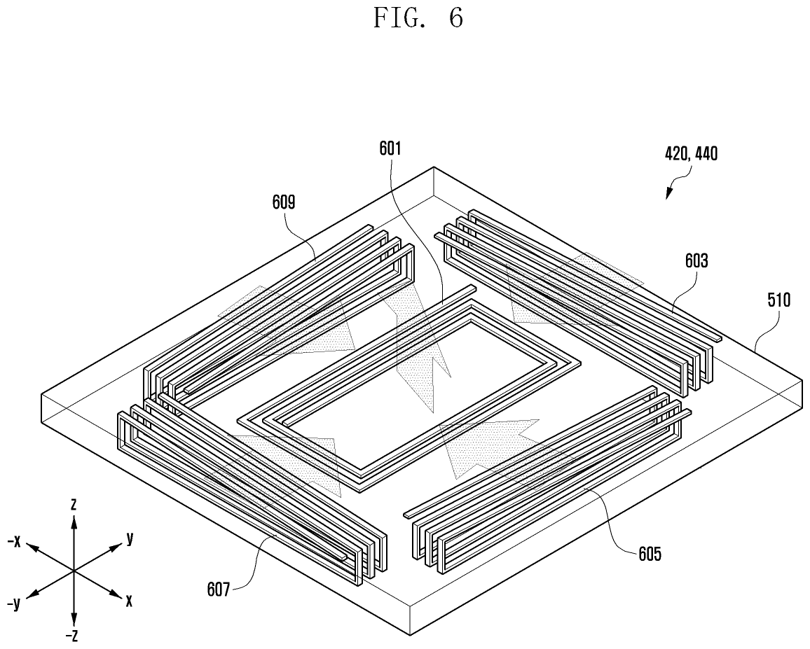

According to an embodiment of the disclosure, the power transmission coil 311k may wirelessly transmit power to a power reception coil 321k of the electronic device 101. The power transmission coil 311k may include multiple coils grouped on the same layer and/or on different layers. The wireless charging device 301 may select some of the multiple coils disposed on the same layer and/or different layers to charge the battery 321e of the electronic device 101. The power transmission coil 311k may be formed by being wound at least once on a printed circuit board (e.g., the printed circuit board 510 in FIG. 5 or the printed circuit board 110 in FIG. 6).

According to an embodiment of the disclosure, the first coil 420 may receive power transmitted through the first converter 415 and may operate as an electromagnet. For example, the first coil 420 may be disposed inside the power transmission coil 311k. For example, the first coil 420 may form a magnetic field in the first direction 401 (e.g., the z-axis direction).

According to various embodiments of the disclosure, the electronic device 101 may include the power reception coil 321k, a second coil 440, a second impedance compensation circuit 431, a second rectification circuit 433, a second converter 435, and/or the battery 321e.

According to an embodiment of the disclosure, the electronic device 101 may receive power from the wireless charging device 301 via the power reception coil 321k and charge the battery 321e.

According to an embodiment of the disclosure, the power reception coil 321k may receive wireless power from the power transmission coil 311k of the wireless charging device 301. The power reception coil 321k may generate an alternating current when a magnetic field is received via the power transmission coil 311k of the wireless charging device 301. The power reception coil 321k may be formed by being wound at least once on a printed circuit board (e.g., the printed circuit board 510 in FIG. 5 or the printed circuit board 510 in FIG. 6).

According to an embodiment of the disclosure, the second coil 440 may receive power transmitted through the second rectification circuit 433 and operate as an electromagnet. For example, the second coil 440 may be disposed inside the power reception coil 321k. For example, the second coil 440 may form a magnetic field in a second direction 402 (e.g., the −z-axis direction).

According to various embodiments of the disclosure, the first coil 420 may form a magnetic field in the first direction 401 (e.g., the z-axis direction) and may operate as an N-pole. For example, the second coil 440 may form a magnetic field in the second direction 402 (e.g., the −z-axis direction) and may operate as an S-pole. For example, when the first coil 420 and the second coil 440 operate as electromagnets, the polarities of the first coil 420 and the second coil 440 may be different from each other. When the first coil 420 and the second coil 440 operate as electromagnets, the polarities of the first coil 420 and the second coil 440 may be opposite to each other. The first coil 420 of the wireless charging device 301 and the second coil 440 of the electronic device 101 may operate as electromagnets with different polarities, thereby enhancing the attachment force.

According to various embodiments of the disclosure, the first coil 420 of the wireless charging device 301 and the second coil 440 of the electronic device 101 may be matched, such that the power transmission coil 311k and the power reception coil 321k are aligned, thereby improving wireless charging efficiency.

According to an embodiment of the disclosure, the second impedance compensation circuit 431 may compensate for the impedance of wireless power (e.g., alternating current power) received via the power reception coil 321k.

According to an embodiment of the disclosure, the second rectification circuit 433 may convert alternating current transmitted through the second impedance compensation circuit 431 to direct current. The second rectification circuit 433 may transmit power, which has been input through the battery 321e, to the second coil 440. The second coil 440 may receive power via the second rectification circuit 433 and may operate as an electromagnet. For example, the second coil 440 may form a magnetic field in the second direction 402 (e.g., the −z-axis direction).

According to an embodiment of the disclosure, the second converter 435 may convert power rectified by the second rectification circuit 433 to a configured gain. The second converter 435 may convert the rectified power such that a voltage at an output end charges the battery 321e. The second converter 435 may transmit the converted power to the battery 321e, and may charge the battery 321e.

According to various embodiments of the disclosure, the second converter 435 may include a DC-DC converter capable of converting to a voltage used by the electronic device 101. For example, the second converter 435 may step down or step up the voltage used by the electronic device 101.

According to an embodiment of the disclosure, the battery 321e may store and charge the converted power that is input via the second converter 435.

FIG. 5 schematically illustrates a configuration of a first coil or a second coil according to an embodiment of the disclosure.

Referring to FIG. 5, according to an embodiment of the disclosure, the first coil 420 and the second coil 440 illustrated in FIG. 4 may include substantially identically formed coil patterns, as illustrated in FIG. 5. For example, the first coil 420 and the second coil 440 may include substantially identical coil patterns and may differ only in the direction of a magnetic field.

According to an embodiment of the disclosure, the first coil 420 or the second coil 440 may include, for example, a first coil pattern 501, a second coil pattern 503, a third coil pattern 505, a fourth coil pattern 507, and/or a fifth coil pattern 509 disposed on a printed circuit board 510.

According to various embodiments of the disclosure, as long as the first coil 420 or the second coil 440 is capable of operating as an electromagnet, the first coil 420 or the second coil 440 may include only at least one coil pattern among the first coil pattern 501 to the fifth coil pattern 509.

According to an embodiment of the disclosure, the printed circuit board 510 may include a structure in which multiple printed circuit boards (PCBs) are stacked. The printed circuit board 510 may include an interposer structure. The printed circuit board 510 may include at least one via. For example, the printed circuit board 510 may take the form of a flexible printed circuit board (FPCB) and/or a rigid printed circuit board (PCB).

According to various embodiments of the disclosure, the first coil pattern 501, the second coil pattern 503, the third coil pattern 505, the fourth coil pattern 507, and/or the fifth coil pattern 509 may be disposed on the printed circuit board 510.

According to an embodiment of the disclosure, the first coil pattern 501 may be formed by being wound at least once on the printed circuit board 510. For example, the first coil pattern 501 may be disposed on one side (e.g., in the −x-axis direction) of the printed circuit board 510 and formed by winding a coil at least once in the upward direction (e.g., the z-axis direction) of the printed circuit board 510. For example, the first coil pattern 501 may be formed in a three-dimensional structure. For example, the first coil pattern 501 may form a magnetic field toward a first side (e.g., in the x-axis direction).

According to an embodiment of the disclosure, the second coil pattern 503 may be formed by being wound at least once on the printed circuit board 510. For example, the second coil pattern 503 may be disposed at a first side (e.g., in the x-axis direction) of the first coil pattern 501. The second coil pattern 503 may be formed by winding a coil at least once along a first side (e.g., a plane in the x-axis direction) of the printed circuit board 510. For example, the second coil pattern 503 may be formed in a planar structure. For example, the second coil pattern 503 may form a magnetic field in a first direction (e.g., the z-axis direction).

According to an embodiment of the disclosure, the third coil pattern 505 may be formed by being wound at least once on the printed circuit board 510. For example, the third coil pattern 505 may be disposed at a first side (e.g., in the x-axis direction) of the second coil pattern 503. The third coil pattern 503 may be formed by winding a coil at least once in the upward direction (e.g., the z-axis direction) of the printed circuit board 510. For example, the third coil pattern 503 may be formed in a three-dimensional structure. For example, the third coil pattern 503 may form a magnetic field toward a second side (e.g., the −x-axis direction).

According to an embodiment of the disclosure, the fourth coil pattern 507 may be formed by being wound at least once on the printed circuit board 510. For example, the fourth coil pattern 507 may be disposed at a first side (e.g., in the x-axis direction) of the third coil pattern 505. The fourth coil pattern 507 may be formed by winding a coil at least once along the first side (e.g., in the x-axis direction) of the printed circuit board 510. For example, the fourth coil pattern 507 may be formed in a planar structure. For example, the fourth coil pattern 507 may form a magnetic field in a second direction (e.g., the −z-axis direction).

According to an embodiment of the disclosure, the fifth coil pattern 509 may be formed by being wound at least once on the printed circuit board 510. For example, the fifth coil pattern 509 may be disposed at a first side (e.g., in the x-axis direction) of the fourth coil pattern 507. The fifth coil pattern 509 may be formed by winding a coil at least once in the upward direction (e.g., the z-axis direction) of the printed circuit board 510. For example, the fifth coil pattern 509 may be formed in a three-dimensional structure. For example, the fifth coil pattern 509 may form a magnetic field toward the first side (e.g., in the x-axis direction).

According to various embodiments of the disclosure, the directions of the magnetic fields of the first coil pattern 501 and the third coil pattern 505 may be different from each other (e.g., the X-axis direction and the −X-axis direction). The directions of the magnetic fields of the first coil pattern 501 and the fifth coil pattern 509 may be substantially the same (e.g., the x-axis direction) as each other. The directions of the magnetic fields of the second coil pattern 503 and the fourth coil pattern 507 may be different from each other (e.g., the z-axis direction and in the −z-axis direction).

According to various embodiments of the disclosure, when the magnetic field of the first coil 420 is formed in a first direction 401 (e.g., the z-axis direction), the magnetic field of the second coil 440 may be formed in a second direction 402 (e.g., the −z-axis direction) that is opposite to the first direction 401 (e.g., the z-axis direction).

FIG. 6 schematically illustrates a configuration of a first coil or a second coil according to an embodiment of the disclosure.

Referring to FIG. 6, according to an embodiment of the disclosure, the first coil 420 and the second coil 440 illustrated in FIG. 4 may include substantially identically formed coil patterns, as illustrated in FIG. 6. For example, the first coil 420 and the second coil 440 may include substantially identical coil patterns and may differ only in the direction of a magnetic field.

According to an embodiment of the disclosure, the first coil 420 or the second coil 440 may include, for example, a first coil pattern 601, a second coil pattern 603, a third coil pattern 505, a fourth coil pattern 607, and/or a fifth coil pattern 609 disposed on a printed circuit board 510.

According to various embodiments of the disclosure, as long as the first coil 420 or the second coil 440 is capable of operating as an electromagnet, the first coil 420 or the second coil 440 may include only at least one coil pattern among the first coil pattern 601 to the fifth coil pattern 509.

According to an embodiment of the disclosure, the printed circuit board 510 may include a structure in which multiple printed circuit boards (PCBs) are stacked. The printed circuit board 510 may include an interposer structure. The printed circuit board 510 may include at least one via. For example, the printed circuit board 510 may include a flexible printed circuit board (FPCB) and/or a rigid printed circuit board (PCB).

According to various embodiments of the disclosure, the first coil pattern 601, the second coil pattern 603, the third coil pattern 605, the fourth coil pattern 607, and/or the fifth coil pattern 609 may be disposed on the printed circuit board 510.

According to an embodiment of the disclosure, the first coil pattern 601 may be formed by being wound at least once on the printed circuit board 510. For example, the first coil pattern 601 may be disposed in the center of the printed circuit board 510. For example, the first coil pattern 601 may be formed in a planar structure. For example, the first coil pattern 601 may form a magnetic field in a first direction (e.g., the z-axis direction). The first coil pattern 601 may be surrounded by the second coil pattern 603, the third coil pattern 605, the fourth coil pattern 607, and the fifth coil pattern 609.

According to an embodiment of the disclosure, the second coil pattern 603 may be disposed at a first side (e.g., in the y-axis direction) of the first coil pattern 601. The second coil pattern 603 may be formed by winding a coil at least once in the upward direction (e.g., the z-axis direction) of the printed circuit board 510. For example, the second coil pattern 603 may be formed in a three-dimensional structure. For example, the second coil pattern 603 may form a magnetic field toward the first coil pattern 601 (e.g., in the −y-axis direction).

According to an embodiment of the disclosure, the third coil pattern 605 may be disposed at a second side (e.g., in the x-axis direction) of the first coil pattern 601. The third coil pattern 605 may be formed by winding a coil at least once in the upward direction (e.g., in the z-axis direction) of the printed circuit board 510. For example, the third coil pattern 605 may be formed in a three-dimensional structure. For example, the third coil pattern 605 may form a magnetic field toward the first coil pattern 601 (e.g., in the −x-axis direction).

According to an embodiment of the disclosure, the fourth coil pattern 607 may be disposed at a third side (e.g., in the −y-axis direction) of the first coil pattern 601. The fourth coil pattern 607 may be formed by winding a coil at least once in the upward direction (e.g., in the z-axis direction) of the printed circuit board 510. For example, the fourth coil pattern 607 may be formed in a three-dimensional structure. For example, the fourth coil pattern 607 may form a magnetic field toward the first coil pattern 601 (e.g., in the y-axis direction).

According to an embodiment of the disclosure, the fifth coil pattern 609 may be disposed at a fourth side (e.g., in the −x-axis direction) of the first coil pattern 601. The fifth coil pattern 609 may be formed by winding a coil at least once in the upward direction (e.g., in the z-axis direction) of the printed circuit board 510. For example, the fifth coil pattern 609 may be formed in a three-dimensional structure. For example, the fifth coil pattern 609 may form a magnetic field toward the first coil pattern 601 (e.g., in the x-axis direction).

According to various embodiments of the disclosure, the magnetic fields of the second coil pattern 603 and the fifth coil pattern 609 may be formed to face the first coil pattern 601 disposed at a substantial center of the printed circuit board 510. The first coil pattern 601, the second coil pattern 603, the third coil pattern 605, the fourth coil pattern 607, and the fifth coil pattern 609 may be formed in a three-dimensional structure and/or a planar structure.

According to various embodiments of the disclosure, when the magnetic field of the first coil 420 disposed in the wireless charging device 301 is formed in a first direction 401 (e.g., the z-axis direction), the magnetic field of the second coil 440 disposed in the electronic device 101 may be formed in a second direction 402 (e.g., the −z-axis direction) opposite to the first direction 401 (e.g., the z-axis direction).

A wireless charging device 301, according to an embodiment of the disclosure, may include a power transmission coil 311k configured to wirelessly transmit power to an electronic device 101 and a first coil 420 disposed inside the power transmission coil 311k and configured to form a magnetic field in a first direction.

According to an embodiment of the disclosure, the electronic device 101 may include a power reception coil 321k configured to wirelessly receive power from the power transmission coil 311k, and a second coil 440 disposed inside the power reception coil 321k and configured to form a magnetic field in a second direction opposite to the first direction.

According to an embodiment of the disclosure, the power transmission coil 311k and the power reception coil 321k may be configured to be aligned when the first coil 420 and the second coil 440 are matched.

According to an embodiment of the disclosure, the first coil 420 and the second coil 440 may be configured to operate as electromagnets.

According to an embodiment of the disclosure, the first coil 420 and the second coil 440 may be configured to have opposite polarities.

According to an embodiment of the disclosure, the first coil 420 may include a first coil pattern 501 disposed on a printed circuit board 510 and a second coil pattern 503 disposed at a side of the first coil pattern 501.

According to an embodiment of the disclosure, the first coil pattern 501 may include a coil wound at least once in the upward direction of the printed circuit board 510, and the second coil pattern 503 may include a coil wound at least once on a plane of the printed circuit board 510.

According to an embodiment of the disclosure, magnetic fields of the first coil pattern 501 and the second coil pattern 503 may be formed to face different directions.

According to an embodiment of the disclosure, the second coil 440 may include a first coil pattern 501 disposed on a printed circuit board 510 and a second coil pattern 503 disposed at a side of the first coil pattern 501.

According to an embodiment of the disclosure, the first coil pattern 501 may include a coil wound at least once in the upward direction of the printed circuit board 510, and the second coil pattern 503 may include a coil wound at least once on a plane of the printed circuit board 510.

According to an embodiment of the disclosure, magnetic fields of the first coil pattern 501 and the second coil pattern 503 may be formed to face different directions.

According to an embodiment of the disclosure, the first coil 420 may include a first coil pattern 601 disposed in the center of a printed circuit board 510, a second coil pattern 603 disposed at a first side of the first coil pattern 601, a third coil pattern 605 disposed at a second side of the first coil pattern 601, a fourth coil pattern 607 disposed at a third side of the first coil pattern 601, and a fifth coil pattern 609 disposed at a fourth side of the first coil pattern 601.

According to an embodiment of the disclosure, the first coil pattern 601 may be formed in a planar structure with a coil wound at least once, and at least one of the second coil pattern 603, the third coil pattern 605, the fourth coil pattern 607, and the fifth coil pattern 609 may be formed in a three-dimensional structure with a coil wound at least once.

According to an embodiment of the disclosure, magnetic fields of the first coil pattern 601, the second coil pattern 603, the third coil pattern 605, the fourth coil pattern 607, and the fifth coil pattern 609 may be formed to face different directions.

According to an embodiment of the disclosure, the wireless charging device 301 may include a first rectification circuit 413 configured to convert alternating current received from a power supply 411 to direct current, and a first converter 415 configured to convert power rectified by the first rectification circuit 413 and transmit the converted power to the power transmission coil 311k and the first coil 420.

According to an embodiment of the disclosure, the wireless charging device 301 may further include an inverter 417 configured to convert direct current received via the first converter 415 to alternating current, and a first impedance compensation circuit 419 configured to compensate for the impedance of the alternating power transmitted via the inverter 417 and transmit the impedance-compensated alternating power to the power transmission coil 311k.

According to an embodiment of the disclosure, the electronic device 101 may include a second impedance compensation circuit 431 configured to compensate for the impedance of wireless power received via the power reception coil 321k, a second rectification circuit 433 configured to convert alternating current transmitted via the second impedance compensation circuit 431 to direct current, and a second converter 435 configured to convert power rectified by the second rectification circuit 433 and transmit the converted power to a battery 321e.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a wireless charging device,
wherein the wireless charging device comprises:
a power transmission coil configured to wirelessly transmit power to the electronic device, and
a first coil disposed inside the power transmission coil and configured to form a magnetic field in a first direction,
wherein ‘the electronic device comprises:
a power reception coil configured to wirelessly receive power from the power transmission coil, and
a second coil disposed inside the power reception coil and configured to form a magnetic field in a second direction opposite to the first direction, and
wherein the first coil and the second coil are configured to be matched so that the power transmission coil and the power reception coil are aligned.

2. The electronic device of claim 1, wherein the first coil and the second coil are configured to operate as electromagnets.

3. The electronic device of claim 1, wherein the first coil and the second coil are configured to have opposite polarities.

4. The electronic device of claim 1, wherein the first coil comprises:
a first coil pattern disposed on a printed circuit board; and
a second coil pattern disposed at a side of the first coil pattern.

5. The electronic device of claim 4,
wherein the first coil pattern comprises a coil wound at least once in an upward direction of the printed circuit board, and
wherein the second coil pattern comprises a coil wound at least once on a plane of the printed circuit board.

6. The electronic device of claim 5, wherein magnetic fields of the first coil pattern and the second coil pattern are configured to face different directions.

7. The electronic device of claim 1, wherein the second coil comprises:
a first coil pattern disposed on a printed circuit board; and
a second coil pattern disposed at a side of the first coil pattern.

8. The electronic device of claim 7,
wherein the first coil pattern comprises a coil wound at least once in an upward direction of the printed circuit board, and
wherein the second coil pattern comprises a coil wound at least once on a plane of the printed circuit board.

9. The electronic device of claim 8, wherein magnetic fields of the first coil pattern and the second coil pattern are configured to face different directions.

10. The electronic device of claim 1, wherein the first coil comprises:
a first coil pattern disposed in a center of a printed circuit board;
a second coil pattern disposed at a first side of the first coil pattern;
a third coil pattern disposed at a second side of the first coil pattern;
a fourth coil pattern disposed at a third side of the first coil pattern; and
a fifth coil pattern disposed at a fourth side of the first coil pattern.

11. The electronic device of claim 10,
wherein the first coil pattern is formed in a planar structure with a coil wound at least once, and
wherein at least one of the second coil pattern, the third coil pattern, the fourth coil pattern, and the fifth coil pattern is formed in a three-dimensional structure with a coil wound at least once.

12. The electronic device of claim 11, wherein magnetic fields of the first coil pattern, the second coil pattern, the third coil pattern, the fourth coil pattern, and the fifth coil pattern are configured to face different directions.

13. The electronic device of claim 1, wherein the wireless charging device comprises:
a first rectification circuit configured to convert alternating current received from a power supply to direct current; and
a first converter configured to:
convert power rectified by the first rectification circuit, and
transmit the converted power to the power transmission coil and the first coil.

14. The electronic device of claim 13, wherein the wireless charging device further comprises:
an inverter configured to convert direct current received via the first converter to alternating current; and
a first impedance compensation circuit configured to:
compensate for impedance of alternating power transmitted via the inverter, and
transmit the impedance-compensated alternating power to the power transmission coil.

15. The electronic device of claim 1, further comprising:
a second impedance compensation circuit configured to compensate for impedance of wireless power received via the power reception coil;
a second rectification circuit configured to convert alternating current transmitted via the second impedance compensation circuit to direct current; and
a second converter configured to:
convert power rectified by the second rectification circuit, and
transmit the converted power to a battery.
